(19) United States
(12) Patent Application Publication
(10) Pub. No.: US 2025/0310866 A1
(43) Pub. Date: Oct. 2, 2025

(54) EXTENDING SYNCHRONIZATION SIGNAL BLOCK PERIODICITIES FOR NON-TERRESTRIAL NETWORKS

(71) Applicant: QUALCOMM Incorporated, San Diego, CA (US)

(72) Inventors: Alberto RICO ALVARINO, San Diego, CA (US); Peter GAAL, San Diego, CA (US); Le LIU, San Jose, CA (US); Xiao Feng WANG, San Diego, CA (US); Jae Ho RYU, San Diego, CA (US); Changhwan PARK, San Diego, CA (US)

(21) Appl. No.: 19/096,434

(22) Filed: Mar. 31, 2025

Related U.S. Application Data
(60) Provisional application No. 63/572,646, filed on Apr. 1, 2024.

(51) Int. Cl. H04W 48/16; H04W 24/08; H04W 60/00; H04W 76/10

(52) U.S. Cl. CPC H04W 48/16; H04W 24/08; H04W 60/00; H04W 76/10

(57) ABSTRACT

Methods, systems, and devices for wireless communications are described. For example, a user equipment (UE) may perform a cell search process over a channel raster to communicate with one or more cells. The cell search may include monitoring first and second subsets of raster points at first and second periodicities for synchronization signal blocks. The second periodicity may be longer than the first periodicity. The UE may obtain the second subset based on a configuration, a received indication, or both. In some examples, the UE may combine two groups of raster points obtained from different sources to form the second subset. In some examples, the UE may prioritize the raster points if the combined group exceeds a quantity threshold. The UE may determine the presence of, and communicate with, the one or more cells in the first or second subsets based on monitoring the subsets.

### CROSS REFERENCES

The present Application for Patent claims benefit of U.S. Provisional Patent Application No. 63/572,646 by RICO ALVARINO et al., entitled “EXTENDING SYNCHRONIZATION SIGNAL BLOCK PERIODICITIES FOR NON-TERRESTRIAL NETWORKS,” filed Apr. 1, 2024, assigned to the assignee hereof, and expressly incorporated herein.

### FIELD OF TECHNOLOGY

The following relates to wireless communications, including extending synchronization signal block periodicities for non-terrestrial networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may include non-terrestrial (NT) network entities that may respectively transmit multiple beams in accordance with a power capability of a respective NT network entity.

### SUMMARY

The described techniques relate to improved methods, systems, devices, and apparatuses that support extending synchronization signal block periodicities for non-terrestrial networks. For example, the described techniques provide for a user equipment (UE) performing a cell search process over a channel raster associated with a wireless spectrum to communicate with one or more cells. The cell search process may include monitoring for synchronization signal blocks (SSBs) over a first subset and a second subset of raster points of the channel raster at a first periodicity and a second periodicity, respectively. The second periodicity may be longer than the first periodicity, and the UE may indicate a capability to support the second periodicity. The UE may determine the second subset of raster points based on channel number or frequency band associated with the raster points. The UE may be preconfigured with the second subset of raster points, or the second subset of raster points may be indicated by information contained in a subscriber identity module (SIM). The UE may also receive an indication of the second subset of raster points prior to performing the cell search process (e.g., via a configuration or indication from a network entity). In some cases, the UE may combine a first and second group of raster points, associated with the second periodicity, to obtain the second subset. The combination may involve applying prioritization criteria if the combined group exceeds a quantity threshold (e.g., the UE may support a quantity of raster points associated with the second periodicity). The UE may determine a presence of one or more cells in the first or second subsets based on monitoring the subsets in accordance with their respective periodicities, and the UE may communicate with the one or more cells based on determining their presence.

A method for wireless communications by a UE is described. The method may include performing a cell search process over a channel raster associated with a wireless spectrum, where performing the cell search process includes, monitoring, in accordance with a first periodicity for respective SSBs, a first subset of raster points of the channel raster, monitoring, in accordance with a second periodicity for respective SSBs, a second subset of raster points of the channel raster, and determining a presence of one or more cells in the first subset of raster points or in the second subset of raster points based on the monitoring. The method may also include communicating with one or more cells based on performing the cell search process.

A UE for wireless communications is described. The UE may include one or more memories storing processor executable code, and one or more processors coupled with the one or more memories. The one or more processors may individually or collectively be operable to execute the code to cause the UE to perform a cell search process over a channel raster associated with a wireless spectrum, where performing the cell search process includes, monitor, in accordance with a first periodicity for respective SSBs, a first subset of raster points of the channel raster, monitor, in accordance with a second periodicity for respective SSBs, a second subset of raster points of the channel raster, and determine a presence of one or more cells in the first subset of raster points or in the second subset of raster points based on the monitoring. The one or more processors may individually or collectively be operable to execute the code to cause the UE to communicate with one or more cells based on performing the cell search process.

Another UE for wireless communications is described. The UE may include means for performing a cell search process over a channel raster associated with a wireless spectrum, where performing the cell search process includes, means for monitoring, in accordance with a first periodicity for respective SSBs, a first subset of raster points of the channel raster, means for monitoring, in accordance with a second periodicity for respective SSBs, a second subset of raster points of the channel raster, and means for determining a presence of one or more cells in the first subset of raster points or in the second subset of raster points based on the monitoring. The UE may include means for communicating with one or more cells based on performing the cell search process.

A non-transitory computer-readable medium storing code for wireless communications is described. The code may include instructions executable by one or more processors to perform a cell search process over a channel raster associated with a wireless spectrum, where performing the cell search process includes, monitor, in accordance with a first periodicity for respective SSBs, a first subset of raster points of the channel raster, monitor, in accordance with a second periodicity for respective SSBs, a second subset of raster points of the channel raster, and determine a presence of one or more cells in the first subset of raster points or in the second subset of raster points based on the monitoring. The code may include instructions executable by one or more processors to communicate with one or more cells based on performing the cell search process.

In some examples of the method, UEs, and non-transitory computer-readable medium described herein, the second subset of raster points may be based on information contained in a SIM, a global synchronization channel number, an absolute radio frequency channel number, a frequency band associated with the raster points, a non-terrestrial deployment associated with the one or more cells, a subcarrier spacing, or any combination thereof. In some examples of the method, UEs, and non-transitory computer-readable medium described herein, the second subset of raster points may be a subset of a set of raster points that support the second periodicity.

Some examples of the method, UEs, and non-transitory computer-readable medium described herein may further include operations, features, means, or instructions for performing a registration procedure with a network associated with the one or more cells and receiving, prior to performing the cell search process, an indication of the second subset of raster points, where monitoring the second subset of raster points according to the second periodicity may be based on receiving the indication.

Some examples of the method, UEs, and non-transitory computer-readable medium described herein may further include operations, features, means, or instructions for transmitting an indication of a quantity of supported raster points associated with the second periodicity, where the second subset of raster points includes a quantity of raster points that may be less than or equal to the quantity of the supported raster points. Some examples of the method, UEs, and non-transitory computer-readable medium described herein may further include operations, features, means, or instructions for receiving a message including a set of neighbor cell frequencies, where the message includes the second subset of raster points.

Some examples of the method, UEs, and non-transitory computer-readable medium described herein may further include operations, features, means, or instructions for obtaining a first indication of a first group of raster points associated with the second periodicity, obtaining a second indication of a second group of raster points associated with the second periodicity, and combining the first group of raster points and the second group of raster points to obtain the second subset of raster points.

In some examples of the method, UEs, and non-transitory computer-readable medium described herein, combining the first group of raster points and the second group of raster points may include operations, features, means, or instructions for determining that a combination of the first group of raster points and the second group of raster points exceeds a quantity threshold and applying one or more prioritization criteria to obtain the second subset of raster points from the first and second groups of raster points, where the second subset of raster points satisfies the threshold. In some examples of the method, UEs, and non-transitory computer-readable medium described herein, the one or more prioritization criteria includes a ranking of a source of the first indication and a source of the second indication, respective priorities associated with respective raster points of the first group of raster points and the second group of raster points, or any combination thereof.

Some examples of the method, UEs, and non-transitory computer-readable medium described herein may further include operations, features, means, or instructions for obtaining a first indication of a first group of raster points associated with the second periodicity and a first source, obtaining a second indication of a second group of raster points associated with the second periodicity and a second source, and determining a priority associated with the first source may be higher than a priority associated with the second source to obtain the second subset of raster points from the first group of raster points.

In some examples of the method, UEs, and non-transitory computer-readable medium described herein, the second periodicity may be a fixed duration. In some examples of the method, UEs, and non-transitory computer-readable medium described herein, the fixed duration may be based on a frequency band, a global synchronization channel number, or both. Some examples of the method, UEs, and non-transitory computer-readable medium described herein may further include operations, features, means, or instructions for receiving an indication of the second periodicity, where the second periodicity satisfies a threshold duration and corresponds to a respective raster point.

Some examples of the method, UEs, and non-transitory computer-readable medium described herein may further include operations, features, means, or instructions for transmitting an indication of a capability to support the second periodicity, where the indication includes a respective capability for a respective frequency band, a quantity of raster points the UE supports for the second periodicity, or both.

### BRIEF DESCRIPTION OF THE DRAWINGS

FIGS. 1 and 2 show examples of wireless communications systems that support extending synchronization signal block (SSB) periodicities for non-terrestrial networks (NTNs) in accordance with one or more aspects of the present disclosure.

FIG. 3 shows an example of a cell search process that supports extending SSB periodicities for NTNs in accordance with one or more aspects of the present disclosure.

FIG. 4 shows an example of a process flow that supports extending SSB periodicities for NTNs in accordance with one or more aspects of the present disclosure.

FIGS. 5 and 6 show block diagrams of devices that support extending SSB periodicities for NTNs in accordance with one or more aspects of the present disclosure.

FIG. 7 shows a block diagram of a communications manager that supports extending SSB periodicities for NTNs in accordance with one or more aspects of the present disclosure.

FIG. 8 shows a diagram of a system including a device that supports extending SSB periodicities for NTNs in accordance with one or more aspects of the present disclosure.

FIGS. 9 through 11 show flowcharts illustrating methods that support extending SSB periodicities for NTNs in accordance with one or more aspects of the present disclosure.

### DETAILED DESCRIPTION

Some wireless communications systems may include non-terrestrial networks (NTNs). In some NTNs, a respective non-terrestrial (NT) network entity may transmit multiple beams over an area. However, the NT network entity may not transmit all of the multiple beams simultaneously based on a shared power, radio frequency (RF) constraints, and feeder link bandwidth limit. For example, a first type of NT network entity may have up to 10% of the total beams simultaneously active due to power constraints. A second type of NT network entity may have 1.5% of the total beams active. In some current deployments for initial cell search, a UE may assume that a synchronization signal block (SSB) is transmitted every 20 ms (e.g., a periodicity of 2 frames). In some examples, transmitting an SSB with a first periodicity of 20 ms may result in a relatively large overhead for the NT network entity. For example, for a 15 kHz subcarrier spacing (SCS) with a 1 ms overhead for an SSB every 20 ms, and a system information block (SIB), gives an overhead of 5%, resulting in the first type of NT network entity using half of the beam transmission capacity to transmit SSBs. The second type of NT network entity may not be able to transmit SSBs with a 20 ms periodicity. Thus, it may be desirable to increase the periodicity of SSB transmissions to reduce overhead at the NT network entity. However, increasing the SSB periodicity may dramatically increase UE power consumption and reduce the user experience (e.g., increasing SSB periodicity may increase the duration the UE spends in each raster point and the overall search time).

The techniques described herein enable a UE to assume a first SSB periodicity (e.g., 20 ms) for initial cell selection except for a subset of raster points, where the UE may assume a second SSB periodicity larger than the first periodicity. The raster points with the second SSB periodicity may be predefined in a specification (e.g., in a table or list), configured (e.g., via pre-provisioning or information in a subscriber identity module (SIM)), or indicated by the network (e.g., based on registration with the network or in a broadcast of neighbor cell frequencies by a gNB). In some examples, the UE may receive multiple indications of the raster points (e.g., a UE may be configured with a set of frequencies that are later overridden by a neighbor cell list). In such examples, the UE may either concatenate the multiple raster points or prioritize the raster points to satisfy a threshold quantity of raster points. For example, the UE may support a quantity of points and prioritize the multiple points such that the total quantity of points is below or at the threshold quantity. The prioritization may be based on a source of the raster points, a respective priority indicated by each respective source, or any combination thereof. In some examples, the second SSB periodicity may be a fixed value (e.g., fixed per frequency band) or may be indicated per raster point. Additionally, the UE may transmit an indication of a capability to support the second SSB periodicity, which may be based on a frequency band, a quantity of raster points, or both.

Aspects of the disclosure are initially described in the context of wireless communications systems. Aspects of the disclosure are further illustrated by and described with reference to a cell search procedure and a process flow. Aspects of the disclosure are further illustrated by and described with reference to apparatus diagrams, system diagrams, and flowcharts that relate to extending synchronization signal block periodicities for non-terrestrial networks.

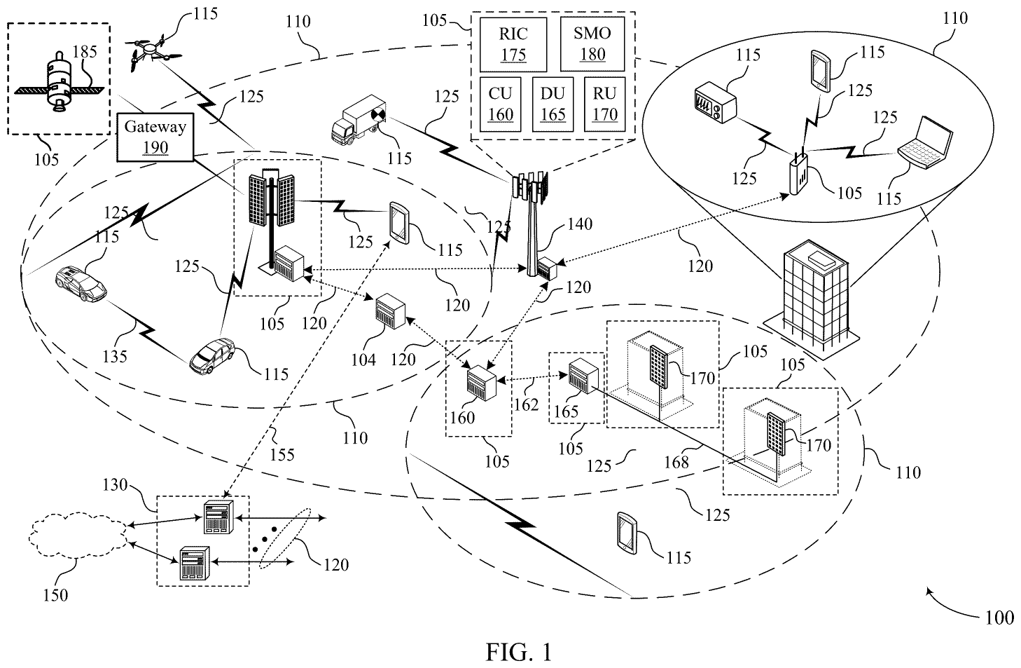

FIG. 1 shows an example of a wireless communications system 100 that supports extending synchronization signal block periodicities for non-terrestrial networks in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., an RF access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

As described herein, a network entity 105 may refer to a terrestrial communication device (such as a base station 140) or a non-terrestrial communication device (such as a satellite 185, a balloon, a drone, a UAS platform, or another non-terrestrial device). An NT network entity 105 may be connected to a terrestrial network entity 105 via a gateway 190. In some examples, an NT network entity 105 may correspond to a first cell type (e.g., a non-terrestrial network cell type), and a terrestrial network entity 105 may correspond to a second cell type (e.g., a terrestrial network cell type) different from the first cell type.

A non-terrestrial network may refer to a network, or one or more segments of networks using RF resources for communications between a UE 115 and a satellite 185 or an unmanned aerial system (UAS) platform. For instance, a UE 115 may communicate with an NT network entity 105 (e.g., a satellite 185 or another non-terrestrial device) via a service link (e.g., a communication links 125), and the NT network entity 105 may be connected to a gateway 190 (e.g., an NTN gateway) via a feeder link (e.g., a backhaul communication link 120). The gateways may be co-located with or in communication with another network entity 105 (e.g., a terrestrial network entity 105 such as a base station 140) and signaling may be communicated between the network entity 105 and the UE 115 via the gateway 190 and the NT network entity 105. An NTN cell may be associated with respective NT network entities 105, and each NT network entity 105 may be associated with one or more gateways 190.

In some examples, a NT network entity 105 may be associated with one or more parameters (e.g., satellite payload parameters) based on power sharing among multiple beams of the NT network entity 105, different beam patterns across a satellite footprint of the NT network entity 105, different beam sizes (e.g., wide or narrow) across the satellite footprint, or any combination thereof. The multiple beams of the NT network entity 105 may not be simultaneously active based on a limit of the power sharing (e.g., the NT network entity 105 may not have a capability to transmit all beams simultaneously). Additionally, or alternatively, the multiple beams may be active below a nominal effective isotropic radiated power (EIRP) density per beam due to a power and feeder link bandwidth based on the power sharing. In some examples, dynamic and flexible power sharing between the multiple beams, different beam patterns, or different beam sizes may be enabled.

A NT network entity 105 may be associated with one or more types of NT network entities 105 corresponding to multiple parameters. For example, a first NT network entity 105 may be a first type of NT network entity 105 (e.g., Set 1-1) with a first quantity of beam footprints (e.g., 1058 footprints), a first quantity of simultaneously active beams at a first power (e.g., 106 beams), a first quantity of active beams at a second power (e.g., 212 beams), and a first percentage of simultaneously active beams (e.g., 10.02%). A second NT network entity 105 may be a second type of NT network entity 105 (e.g., Set 1-2) with a second quantity of beam footprints (e.g., 1058 footprints), a second quantity of simultaneously active beams at a first power (e.g., 16 beams), a second quantity of active beams at a second power (e.g., 16 beams), and a second percentage of simultaneously active beams (e.g., 1.5%). A third NT network entity 105 may be a third type of NT network entity 105 (e.g., Set 1-3) with a third quantity of beam footprints (e.g., 1058 footprints), a third quantity of simultaneously active beams at a first power (e.g., 106 beams), a third quantity of active beams at a second power (e.g., 212 beams), and a third percentage of simultaneously active beams (e.g., 10.02%). In some examples, the third type of NT network entity 105 may include a lower quantity of power per beam compared to the first type of NT network entity 105 (e.g., 31 dBW EIRP per satellite beam compared to 41 dBW EIRP per satellite beam). In some examples, the quantity of active beams may correspond to a quantity of RF chains supported by the NT network entity 105.

In some current deployments for initial cell search, a UE 115 may assume that an SSB is transmitted every 20 ms (e.g., a periodicity of 2 frames). In some examples, transmitting an SSB with a first periodicity of 20 ms may result in a relatively large overhead for a NT network entity 105. For example, a 15 kHz subcarrier spacing (SCS) with a 1 ms overhead for an SSB every 20 ms, and a system information block (SIB)), gives an overhead of 5%, resulting in the first type of NT network entity 105 using half of the beam transmission capacity to transmit SSBs. The second type of NT network entity 105 may not transmit SSBs. Thus, it may be desirable to increase the periodicity of SSB transmissions to reduce overhead at the NT network entity 105. However, increasing the SSB periodicity may dramatically increase UE power consumption and reduce the user experience (e.g., increasing SSB periodicity may increase the duration the UE 115 spends in each raster point).

The techniques described herein enable a UE 115 to assume a first SSB periodicity (e.g., 20 ms) for initial cell selection except for a subset of raster points, where the UE 115 may assume a second SSB periodicity larger than the first periodicity. The raster points with the second SSB periodicity may be predefined in a specification (e.g., in a table or list), configured (e.g., via pre-provisioning), or indicated by the network (e.g., based on registration with the network or in a broadcast of neighbor cell frequencies by a gNB). In some examples, the UE 115 may receive multiple indications of the raster points (e.g., a UE 115 may be configured with a set of frequencies that are later overridden by a neighbor cell list). In such examples, the UE 115 may either concatenate the multiple raster points or prioritize the raster points to satisfy a threshold quantity of raster points. For example, the UE 115 may support the second SSB periodicity for a quantity of points and prioritize the multiple points such that the total quantity of points is below or at the threshold quantity. The prioritization may be based on a source of the raster points, a respective priority indicated by each respective source, or any combination thereof. In some examples, the second SSB periodicity may be a fixed value (e.g., fixed per frequency band) or dynamic per raster point. Additionally, the UE 115 may transmit an indication of a capability to support the second SSB periodicity, which may be based on a frequency band, a quantity of raster points, or both.

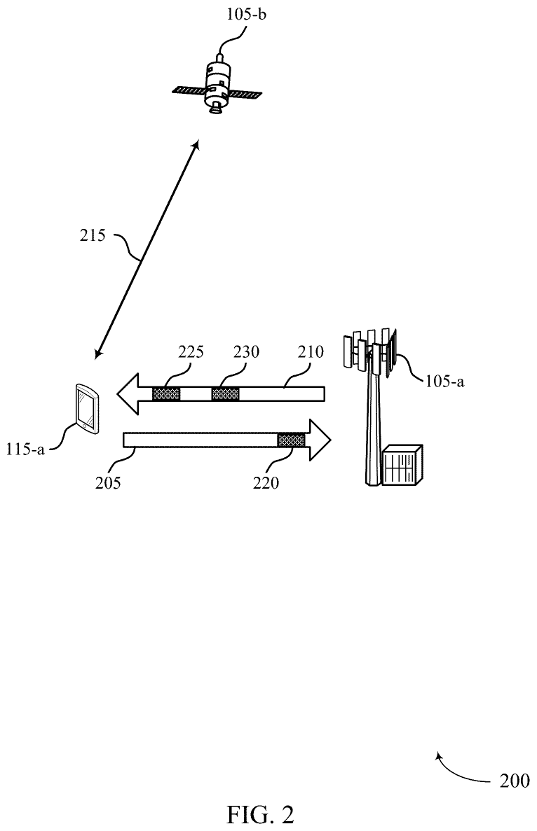

FIG. 2 shows an example of a wireless communications system 200 that supports extending SSB periodicities for NTNs in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a and a network entity 105-b, which may be examples of network entities 105 as described herein. In some cases, the network entity 105-b may be an example of an NT network entity 105 (e.g., a non-terrestrial network cell). The UE 115-a may transmit uplink signals 205 (e.g., uplink transmissions), such as uplink control signals or uplink data signals, to the network entity 105-a, and the network entity 105-a may transmit downlink signals 210 (e.g., downlink transmissions), such as downlink control signals or downlink data signals. Additionally, or alternatively, the UE 115-a may communicate with the NT network entity 105-b via a bi-directional link 215, which may include uplink transmissions and downlink transmissions, based on performing a cell search process described herein.

In some NTNs, a NT network entity 105 may transmit a quantity of beams based on a quantity of power available to the NT network entity 105. For example, a first type of NT network entity 105 (e.g., a Set 1-1 satellite) may simultaneously transmit a fraction of a total quantity of beams (e.g., 10% of the total available beams are active), and a second type of NT network entity 105 (e.g., a Set 1-2 satellite) may transmit a relatively lower fraction of a total quantity of beams (e.g., 1.5% of the total available beams are active). Different types of NT network entities 105 may be based on capability differences, or deployments (e.g., low Earth orbit or geosynchronous Earth orbit), among other examples.

In some wireless communications systems, a network entity 105 may transmit one or more SSBs and SIBs for initial cell search by a UE 115. In some examples, the network entity 105 may transmit the one or more SSBs and SIBs for each active beam. Transmitting the one or more SSBs and SIBs may be associated with an overhead at the network entity 105. For example, with a 15 kHz SCS, a 1 ms overhead for transmitting an SSB every 20 ms and one or more SIB1 may result in an overhead of 5% at the network entity 105.

In some examples, the overhead of transmitting the SSB for a periodicity of 20 ms may impact a quantity of active beam transmissions. For example, half of the active beams the first type of NT network entity 105 may be used to transmit the SSBs. In another example, the second type of NT network entity 105 may not transmit any SSBs. Operating with this overhead may not be desirable. In some examples, SSB periodicity may be increased to reduce overhead. However, an increased SSB periodicity may also increase power consumption and cell search time at a UE 115. For example, if SSB periodicity is increased to 160 ms (e.g., from 20 ms), the UE 115 may spend eight times longer in each raster point compared to a periodicity of 20 ms.

The techniques described herein may enable the UE 115-a to assume a first periodicity (e.g., 20 ms SSB periodicity) for initial cell selection, except for a quantity of raster points for which the UE 115-a may assume a second periodicity (e.g., a larger SSB periodicity). For example, the quantity of raster points may be limited to a subset of a total quantity of raster points (e.g., 5 points overall). The raster points with the second periodicity may be signaled to the UE 115-a in one or more ways. For example, a specification of the UE 115-a may include a table or list including a set of the raster points with the second periodicity. In some examples, the raster points may be defined as a global synchronization channel number (GSCN), an absolute radio frequency channel number (ARFCN), a combination of the GSCN and a frequency band, or as all raster points within a frequency band (e.g., FR1, FR2, FR3, or portions thereof). Additionally, or alternatively, the raster points with the second periodicity may be applicable to non-terrestrial deployments (e.g., NTNs). For example, one or more frequency bands (e.g., FR1, FR2, FR3), or portions of frequency bands, may be associated with an NTN. In some examples, the raster points may be based on a subcarrier spacing (SCS). For example, the raster points may apply based on an SSB with a 15 kHz SCS transmitted in that GSCN (e.g., SCS larger than 15 kHz may be associated with a relatively smaller overhead compared to a 15 kHz SCS).

In some examples, the UE 115-a may be configured (e.g., via pre-provisioning in the SIM) with a set of raster points assumed to have the second periodicity. In some examples, the set of raster points that the UE 115-a may be configured with may be a subset of a set of raster points specified to support the second periodicity. For example, a specification may support a list of raster points (e.g., x₁, x₂, x₃, . . . xₙ) that support the larger SSB periodicity. In some examples, the UE 115-a may be configured with up to L of those raster points, where L may be less than or equal to the total quantity of raster points that support the larger SSB periodicity, N.

Additionally, or alternatively, a network may provide the UE 115-a with the set of raster points based on performing a registration procedure with the network (e.g., during an attach procedure using NAS). The network entity 105-a and the NT network entity 105 may be connected to the network. For example, the network entity 105-a may transmit an indication 225 of the set of raster points. In some examples, the UE 115-a may transmit a capability message 220 of a quantity of supported raster points with the second periodicity, and the network may provide the indication 225 according to the capability message 220. Additionally, or alternatively, the capability message 220 may indicate whether the UE 115-a supports the second periodicity. In some examples, the capability message 220 may include which frequency bands for which the UE 115-a supports the second periodicity (e.g., the capability may be per frequency band).

In some examples, a neighbor cell frequency list may provide the UE 115-a with the set of raster points. For example, the network entity 105-a may broadcast a neighbor cell frequency message 230 indicating a set of neighbor cell frequencies (e.g., in SIB2) that the UE 115-a may use for measurements. The set of neighbor cell frequencies may include the set of raster points with the second periodicity. Additionally, or alternatively, the network entity 105-a may include frequencies with larger periodicities (e.g., more sparse SSBs) in a separate list. The separate list may maintain backward compatibility for the neighbor cell frequency message 230, where legacy UEs 115 may assume a 20 ms periodicity and may not receive the set of raster points with larger periodicities.

The UE 115-a may obtain the set of raster points from multiple sources. For example, the UE 115-a may be configured with a set of frequencies that may be overridden by receiving a neighbor cell frequency list including raster points. In such examples, the UE 115-a may concatenate all the information of the raster points. For example, the UE 115-a may combine the configured set of frequencies associated with the second periodicity with the frequencies indicated via the neighbor cell frequency list.

In some examples, the UE 115-a may prioritize a quantity of raster points associated with the second periodicity. For example, the UE 115-a may have a capability for a first quantity of raster points (e.g., a quantity threshold). The UE 115-a may prioritize the raster points such that the total quantity of raster points are less than or equal to the quantity threshold. For example, the UE 115-a may rank and prioritize the raster points according to the source of the raster point (e.g., raster points from SIB having higher priority than raster points from NAS, raster points from NAS having higher priority than raster points from USIM). In some examples, the priority of the raster points may be predefined (e.g., different points may have different priorities). In another example, for each raster point, each respective source may indicate a priority list for the UE 115-a. For example, USIM may indicate {GSCN0, p0}, {GSCN1, p0}, {GSCN2, p1}, NAS may indicate {GSCN3, p1}, {GSCN4, p0}, and SIB may indicate {GSCN5, p2}, {GSCN6, p1}. Based on the source indications, and with an exemplary quantity threshold of four, the UE 115-a may prioritize and keep GSCN5, GSCN6, GSCN3, and GSCN2. In some cases, a priority of one or more raster points may be tied. In such cases, the UE 115-a may decide (e.g., based on GSCN, based on source) which raster points to retain. In some examples, the UE 115-a may prioritize the raster points based on source and ignore raster points received in sources of lower priority (e.g., the UE 115-a may ignore pre-provisioned raster points if the UE 115-a receives raster points in SIB).

In some examples, the second periodicity may be specified as a fixed value (e.g., X ms). For example, the second periodicity may be defined as a fixed duration in a specification. The second periodicity may be different for different GSCNs or frequency bands (e.g., for a given GSCN, the second periodicity may be fixed to 160 ms and for a different GSCN the second periodicity may be fixed to 80 ms). In other examples, the second periodicity may be specified as a duration no longer than a fixed value (e.g., the periodicity is ≤X ms). Additionally, or alternatively, periodicity for some raster points may be specified per raster point (e.g., there may be a third subset of raster points associated with a third periodicity).

In some examples, the UE 115-a may monitor multiple raster points of a channel raster in a wireless spectrum as part of a cell search process. For example, the UE 115-a may monitor a first subset of raster points in accordance with the first periodicity (e.g., 20 ms) and monitor a second subset of raster points in accordance with the second periodicity (e.g., based on obtaining an indication of the set of raster points associated with the second periodicity). In cases where periodicity may vary by raster point, the UE 115-a may monitor a third subset of raster points in accordance with a third periodicity. Based on monitoring the wireless spectrum, the UE 115-a may determine a presence of one or more cells associated with one or more beams of the NT network entity 105-b. In some examples, the UE 115-a may communicate (e.g., transmit and receive messages) with the NT network entity 105-b via the bi-directional link 215 based on determining the presence of the one or more cells.

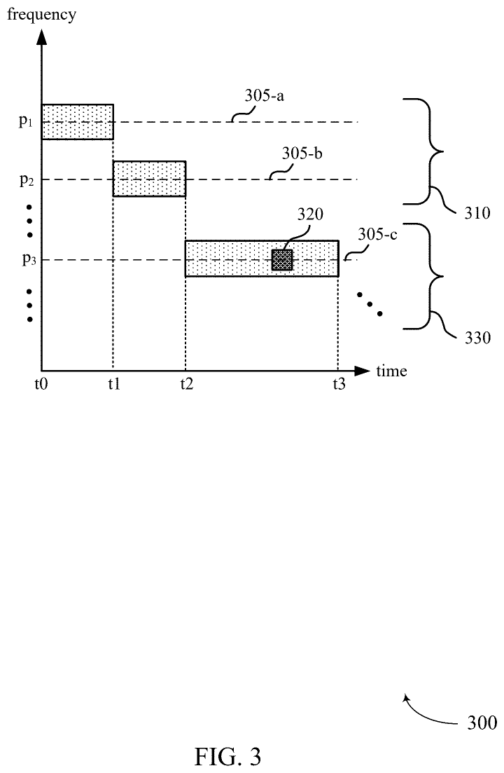

FIG. 3 shows an example of a cell search process 300 that supports extending SSB periodicities for NTNs in accordance with one or more aspects of the present disclosure. FIG. 3 illustrates an example of a UE 115 performing a cell search process to determine a presence of one or more cells associated with a network entity 105 (e.g., a NT network entity). For example, the UE 115 may perform the cell search process over a channel raster associated with a wireless spectrum. The channel raster may include multiple raster points. Each raster point may be associated with one or more frequencies in a frequency band and a duration corresponding to a periodicity. The frequency band may be associated with an NTN (e.g., a NT network entity). The UE 115 may monitor the one or more frequencies for the corresponding duration for each raster point.

For example, the UE 115 may monitor a first subset of raster points 310 in accordance with a first periodicity (e.g., 20 ms). For example, the UE 115 may monitor a first raster point p₁ 305-a (may monitor for an SSB at the raster point 305-a) for a duration t1-t0 and a second raster point p₂ 305-b for a duration t2-t1. The durations t1-t0 and t2-t1 may respectively correspond to the first periodicity.

In some examples, the UE 115 may obtain an indication of one or more raster points associated with a second periodicity (e.g., larger than 20 ms). For example, the UE 115 may be configured with a subset of raster points assumed to have the second periodicity. Additionally, or alternatively, a network associated with the network entity 105 may transmit an indication of the subset of raster points based on a registration procedure between the UE 115 and the network.

The UE 115 may monitor a second subset of raster points 330 in accordance with the second periodicity based on obtaining the indication. For example, the UE 115 may monitor a third raster point p₃ 305-c for a duration t3-t2. The duration t3-t2 may correspond to the second periodicity (e.g., a periodicity greater than 20 ms). In some examples, the UE 115 may assume the second periodicity is a duration (e.g., 80 ms). In other examples, the UE 115 may assume the second periodicity is no longer than a duration. In some examples, the duration t3-t2 may include an SSB 320. Based on receiving the SSB 320, the UE 115 may determine a presence of one or more cells indicated by the SSB 320 and communicate with the one or more cells.

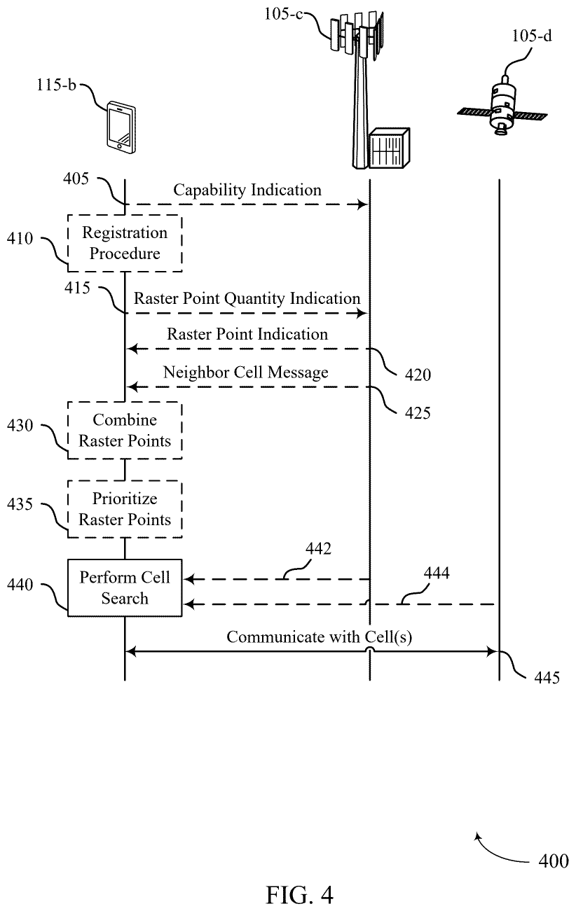

FIG. 4 shows an example of a process flow 400 that supports extending SSB periodicities for NTNs in accordance with one or more aspects of the present disclosure. The process flow 400 may be implemented by aspects of the wireless communications system 100 and 200. For example, a UE 115-b, a network entity 105-c, and an NT network entity 105-d, which may be examples of a UE 115 or network entity 105 as described herein, may perform aspects of the process flow 400. In the following description of the process flow 400, operations performed by the UE 115-b, the network entity 105-c, and the NT network entity 105-d may be performed in a different order than is shown. Some operations may be omitted from the process flow 400, and other operations may be added to the process flow 400. Further, although some operations or signaling may be shown to occur at different times for discussion purposes, these operations may occur at the same time.

In some examples, at 405, the UE 115-b may transmit an indication of a capability to support the second periodicity (e.g., a larger SSB periodicity than a first SSB periodicity). The capability indication may include a respective capability for the second periodicity for a respective frequency band, a quantity of raster points the UE 115-b supports for the second periodicity, or both. In some examples, the network entity 105-c may include the capability in a message to one or more other network entities 105 (e.g., the message may be sent to a gNB or from a CU to a DU to provide paging for the UE 115-b in idle or inactive modes).

At 410, the UE 115-b may perform a registration procedure with a network. For example, the network entity 105-c, the NT network entity 105-d, or both may be included in the network. In some examples, at 415, the UE 115-b may transmit an indication of a quantity of supported raster points associated with the second periodicity. At 420, the UE 115-b may receive an indication of a second subset of raster points associated with the second periodicity based on transmitting the quantity of supported raster points to the network entity 105-c. For example, the network may provide a quantity of raster points according to the capability of the UE 115-b. The UE 115-b may also receive an indication of the second periodicity, where the second periodicity satisfies a threshold duration and corresponds to a respective raster point.

At 425, the UE 115-b may receive a message including a set of neighbor cell frequencies. For example, the network entity 105-c may broadcast the set of neighbor cell frequencies in a system information block (e.g., SIB2), which the UE 115-b may use for measurements. In some examples, the message may include the second subset of raster points. In other examples, the UE 115-b may receive the second subset of raster points in a separate list from the set of neighbor cell frequencies. Additionally, or alternatively, the UE 115-b may receive an indication of the second periodicity where the second periodicity satisfies a threshold duration and corresponds to a respective raster point. In some examples, the second periodicity is a fixed duration. In some cases, the fixed duration may be based on a frequency band, a GSCN, or both.

In some examples, at 430, the UE 115-b may combine (e.g., concatenate) a first group of raster points associated with the second periodicity and a second group of raster points associated with the second periodicity to obtain the second subset of raster points. The UE 115-b may obtain the first group from a first source and the second group from a second source (e.g., a configuration, the indication of raster points, the neighbor cell message, etc.). In some examples, the UE 115-b may support a quantity threshold of raster points associated with the second periodicity. In such examples, the UE 115-b may determine that a combination of the first group of raster points and the second group of raster points exceeds the quantity threshold.

For example, at 435, the UE 115-b may apply one or more prioritization criteria to obtain the second subset of raster points from the first and second groups of raster points. In some examples, the second subset of raster points satisfies the quantity threshold. The prioritization criteria may include a ranking of a source of the first indication and a source of the second indication, respective priorities associated with respective raster points of the first group of raster points and the second group of raster points, or any combination thereof.

At 440, the UE 115-b may perform a cell search process over a channel raster associated with a wireless spectrum. The cell search process may include monitoring a first subset of raster points of the channel raster in accordance with the first periodicity for respective SSBs 442, monitoring the second subset of raster points in accordance with the second periodicity for respective SSBs 444, and determining a presence of one or more cells associated with a network entity 105 (e.g., a terrestrial network entity 105-c or a NT network entity 105-d) in the first subset of raster points or in the second subset of raster points. In some examples, the UE 115-b may monitor the second subset of raster points based on receiving the indication of the second subset of raster points from the network entity 105-c. In some cases, the second subset of raster points may be a subset of a set of raster points that support the second periodicity. Additionally, or alternatively, the second subset of raster points may include a quantity of raster points that is less than or equal to the quantity of raster points supported by the UE 115-b. In some examples, the second subset of raster points may be based on information contained in a SIM, a GSCN, an ARFCN, a frequency band associated with the raster points, an NTN deployment associated with the one or more cells, an SCS, or any combination thereof.

At 445, the UE 115-b may communicate with the one or more cells based on performing the cell search process. For example, as described with reference to FIG. 3, the UE 115-b may determine a presence of one or more cells of a network entity 105 (e.g., a terrestrial network entity 105-c or a NT network entity 105-d) based on monitoring the second subset of raster points according to the second periodicity. In some cases, the UE 115-b may perform a random access process via the one or more cells to establish a communication link with the network entity 105 for communication based on determining the presence of the one or more cells. The communication may include downlink communications, uplink communications, or both.

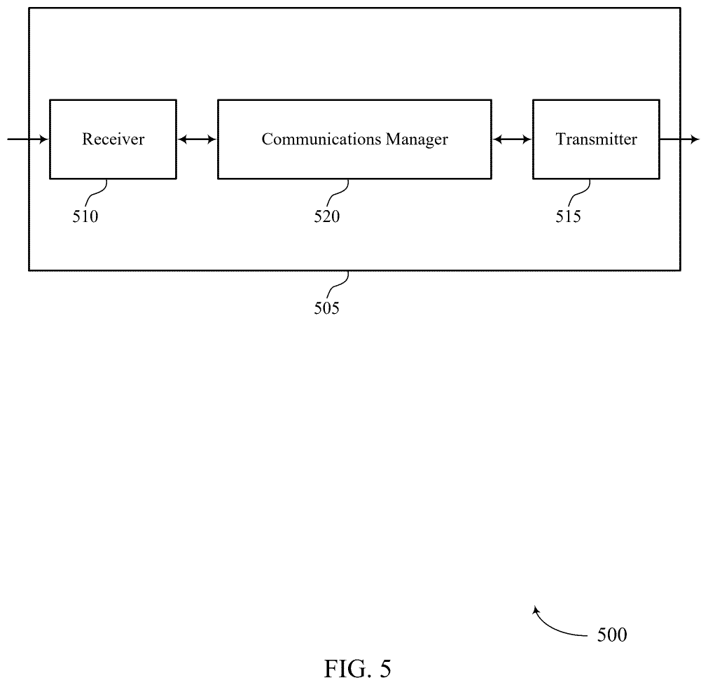

FIG. 5 shows a block diagram 500 of a device 505 that supports extending SSB periodicities for NTNs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to extending SSB periodicities for NTNs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to extending SSB periodicities for NTNs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of extending SSB periodicities for NTNs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for performing a cell search process over a channel raster associated with a wireless spectrum, where performing the cell search process includes monitoring raster points and determining a presence of one or more cells based on the monitoring. The communications manager 520 is capable of, configured to, or operable to support a means for monitoring, in accordance with a first periodicity for respective SSBs, a first subset of raster points of the channel raster. The communications manager 520 is capable of, configured to, or operable to support a means for monitoring, in accordance with a second periodicity for respective SSBs, a second subset of raster points of the channel raster. The communications manager 520 is capable of, configured to, or operable to support a means for determining a presence of one or more cells in the first subset of raster points or in the second subset of raster points based on the monitoring. The communications manager 520 is capable of, configured to, or operable to support a means for communicating with one or more cells based on performing the cell search process.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources (e.g., reduced overhead), among other examples.

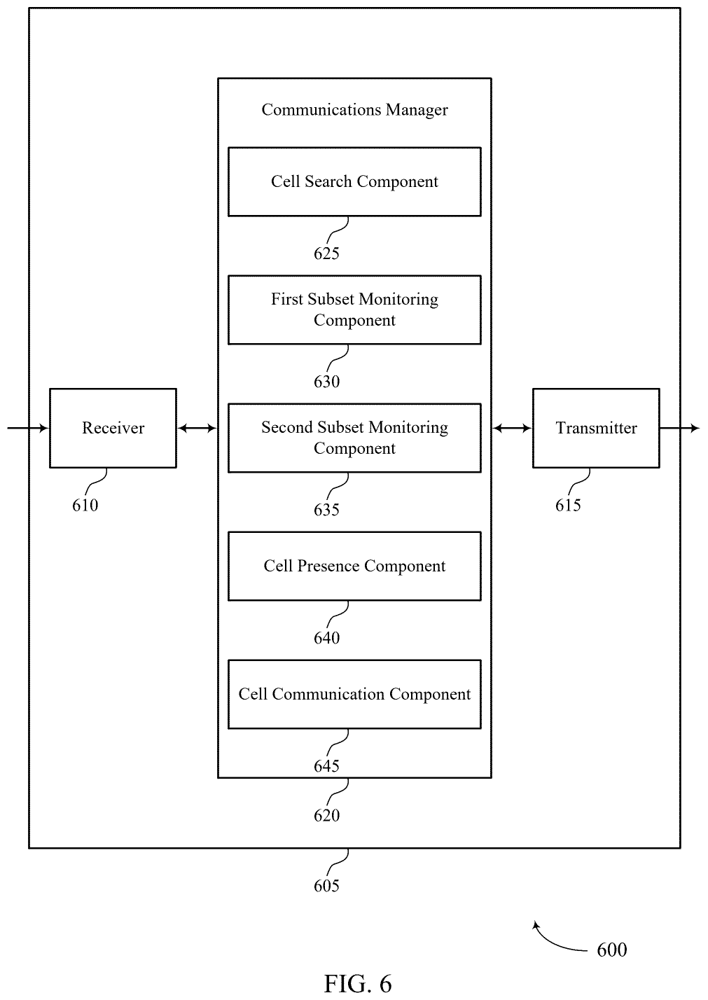

FIG. 6 shows a block diagram 600 of a device 605 that supports extending SSB periodicities for NTNs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to extending SSB periodicities for NTNs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to extending SSB periodicities for NTNs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of extending SSB periodicities for NTNs as described herein. For example, the communications manager 620 may include a cell search component 625, a first subset monitoring component 630, a second subset monitoring component 635, a cell presence component 640, a cell communication component 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The cell search component 625 is capable of, configured to, or operable to support a means for performing a cell search process over a channel raster associated with a wireless spectrum, where performing the cell search process includes monitoring raster points and determining a presence of one or more cells based on the monitoring. The first subset monitoring component 630 is capable of, configured to, or operable to support a means for monitoring, in accordance with a first periodicity for respective SSBs, a first subset of raster points of the channel raster. The second subset monitoring component 635 is capable of, configured to, or operable to support a means for monitoring, in accordance with a second periodicity for respective SSBs, a second subset of raster points of the channel raster. The cell presence component 640 is capable of, configured to, or operable to support a means for determining a presence of one or more cells in the first subset of raster points or in the second subset of raster points based on the monitoring. The cell communication component 645 is capable of, configured to, or operable to support a means for communicating with one or more cells based on performing the cell search process.

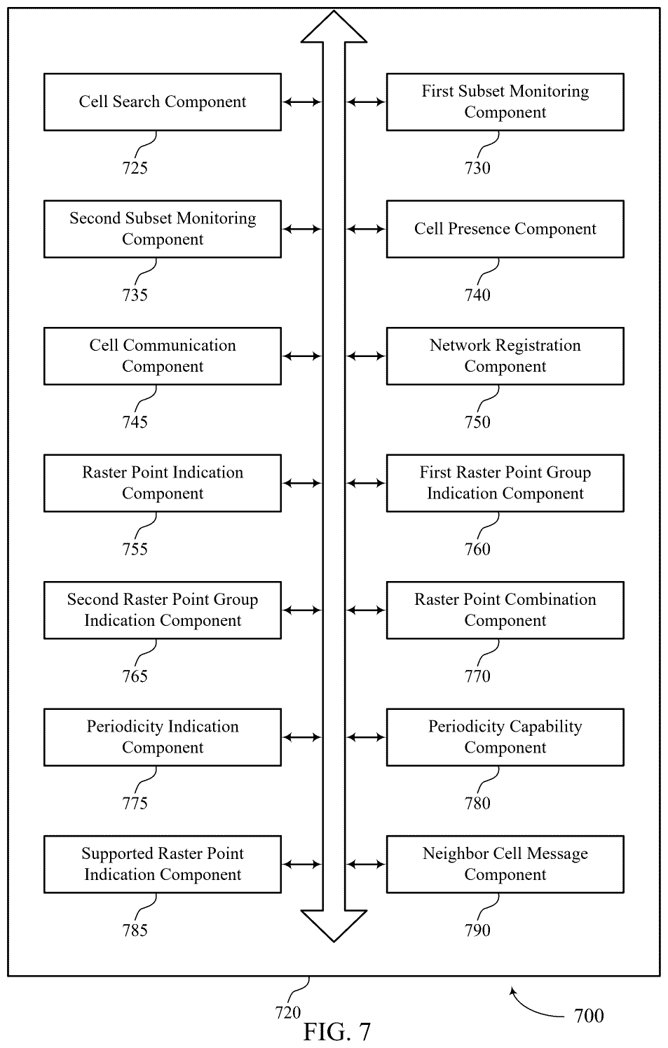

FIG. 7 shows a block diagram 700 of a communications manager 720 that supports extending SSB periodicities for NTNs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of extending SSB periodicities for NTNs as described herein. For example, the communications manager 720 may include a cell search component 725, a first subset monitoring component 730, a second subset monitoring component 735, a cell presence component 740, a cell communication component 745, a network registration component 750, a raster point indication component 755, a first raster point group indication component 760, a second raster point group indication component 765, a raster point combination component 770, a periodicity indication component 775, a periodicity capability component 780, a supported raster point indication component 785, a neighbor cell message component 790, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The cell search component 725 is capable of, configured to, or operable to support a means for performing a cell search process over a channel raster associated with a wireless spectrum, where performing the cell search process includes monitoring raster points and determining a presence of one or more cells based on the monitoring. The first subset monitoring component 730 is capable of, configured to, or operable to support a means for monitoring, in accordance with a first periodicity for respective SSBs, a first subset of raster points of the channel raster. The second subset monitoring component 735 is capable of, configured to, or operable to support a means for monitoring, in accordance with a second periodicity for respective SSBs, a second subset of raster points of the channel raster. The cell presence component 740 is capable of, configured to, or operable to support a means for determining a presence of one or more cells in the first subset of raster points or in the second subset of raster points based on the monitoring. The cell communication component 745 is capable of, configured to, or operable to support a means for communicating with one or more cells based on performing the cell search process.

In some examples, the second subset of raster points are based on information contained in a subscriber identity module, a global synchronization channel number, an absolute radio frequency channel number, a frequency band associated with the raster points, a non-terrestrial deployment associated with the one or more cells, a subcarrier spacing, or any combination thereof. In some examples, the second subset of raster points are a subset of a set of raster points that support the second periodicity.

In some examples, the network registration component 750 is capable of, configured to, or operable to support a means for performing a registration procedure with a network associated with the one or more cells. In some examples, the raster point indication component 755 is capable of, configured to, or operable to support a means for receiving, prior to performing the cell search process, an indication of the second subset of raster points, where monitoring the second subset of raster points according to the second periodicity is based on receiving the indication.

In some examples, the supported raster point indication component 785 is capable of, configured to, or operable to support a means for transmitting an indication of a quantity of supported raster points associated with the second periodicity, where the second subset of raster points includes a quantity of raster points that is less than or equal to the quantity of the supported raster points.

In some examples, the neighbor cell message component 790 is capable of, configured to, or operable to support a means for receiving a message including a set of neighbor cell frequencies, where the message includes the second subset of raster points.

In some examples, the first raster point group indication component 760 is capable of, configured to, or operable to support a means for obtaining a first indication of a first group of raster points associated with the second periodicity. In some examples, the second raster point group indication component 765 is capable of, configured to, or operable to support a means for obtaining a second indication of a second group of raster points associated with the second periodicity. In some examples, the raster point combination component 770 is capable of, configured to, or operable to support a means for combining the first group of raster points and the second group of raster points to obtain the second subset of raster points.

In some examples, to support combining the first group of raster points and the second group of raster points, the raster point combination component 770 is capable of, configured to, or operable to support a means for determining that a combination of the first group of raster points and the second group of raster points exceeds a quantity threshold. In some examples, to support combining the first group of raster points and the second group of raster points, the raster point combination component 770 is capable of, configured to, or operable to support a means for applying one or more prioritization criteria to obtain the second subset of raster points from the first and second groups of raster points, where the second subset of raster points satisfies the threshold.

In some examples, the one or more prioritization criteria includes a ranking of a source of the first indication and a source of the second indication, respective priorities associated with respective raster points of the first group of raster points and the second group of raster points, or any combination thereof.

In some examples, the first raster point group indication component 760 is capable of, configured to, or operable to support a means for obtaining a first indication of a first group of raster points associated with the second periodicity and a first source. In some examples, the second raster point group indication component 765 is capable of, configured to, or operable to support a means for obtaining a second indication of a second group of raster points associated with the second periodicity and a second source. In some examples, the raster point combination component 770 is capable of, configured to, or operable to support a means for determining a priority associated with the first source is higher than a priority associated with the second source to obtain the second subset of raster points from the first group of raster points.

In some examples, the second periodicity is a fixed duration. In some examples, the fixed duration is based on a frequency band, a global synchronization channel number, or both. In some examples, the periodicity indication component 775 is capable of, configured to, or operable to support a means for receiving an indication of the second periodicity, where the second periodicity satisfies a threshold duration and corresponds to a respective raster point.

In some examples, the periodicity capability component 780 is capable of, configured to, or operable to support a means for transmitting an indication of a capability to support the second periodicity, where the indication includes a respective capability for a respective frequency band, a quantity of raster points the UE supports for the second periodicity, or both.

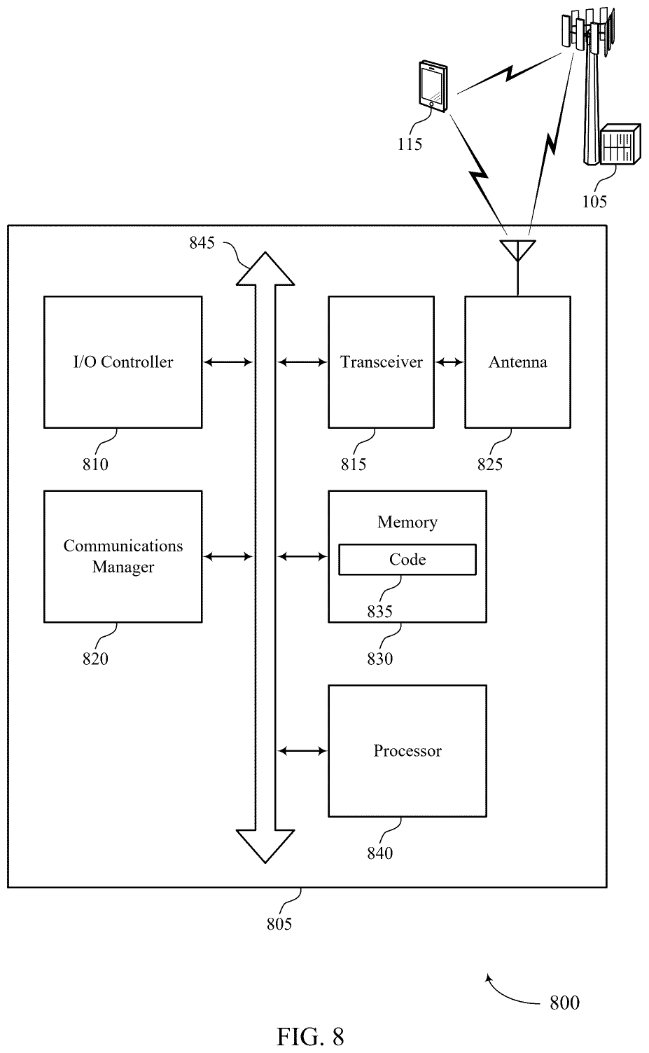

FIG. 8 shows a diagram of a system 800 including a device 805 that supports extending SSB periodicities for NTNs in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting extending SSB periodicities for NTNs). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for performing a cell search process over a channel raster associated with a wireless spectrum, where performing the cell search process includes monitoring raster points and determining a presence of one or more cells based on the monitoring. The communications manager 820 is capable of, configured to, or operable to support a means for monitoring, in accordance with a first periodicity for respective SSBs, a first subset of raster points of the channel raster. The communications manager 820 is capable of, configured to, or operable to support a means for monitoring, in accordance with a second periodicity for respective SSBs, a second subset of raster points of the channel raster. The communications manager 820 is capable of, configured to, or operable to support a means for determining a presence of one or more cells in the first subset of raster points or in the second subset of raster points based on the monitoring. The communications manager 820 is capable of, configured to, or operable to support a means for communicating with one or more cells based on performing the cell search process.

By including or configuring the communications manager 820 in accordance with examples as described herein, the device 805 may support techniques for improved communication reliability, more efficient utilization of communication resources, and improved coordination between devices, among other examples.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of extending SSB periodicities for NTNs as described herein, or the at least one processor 840 and the at least one memory 830 may be otherwise configured to, individually or collectively, perform or support such operations.

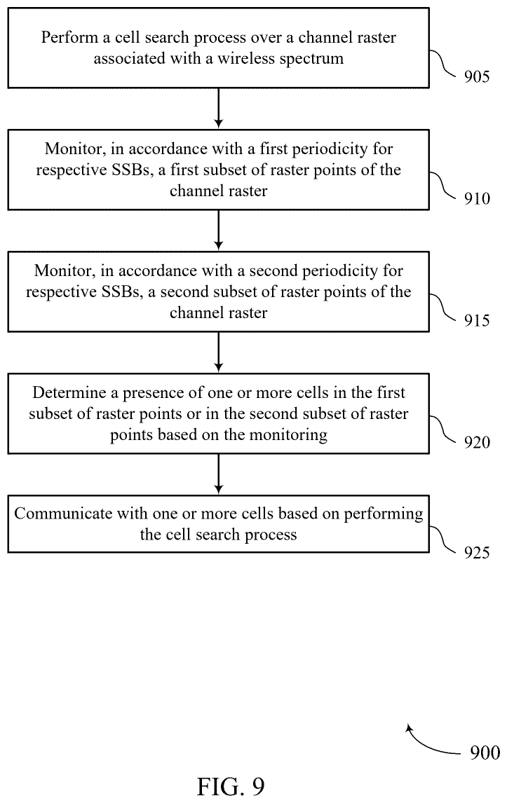

FIG. 9 shows a flowchart illustrating a method 900 that supports extending SSB periodicities for NTNs in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include performing a cell search process over a channel raster associated with a wireless spectrum, where performing the cell search process includes monitoring raster points and determining a presence of one or more cells based on the monitoring. The operations of 905 may be performed in accordance with examples as disclosed herein. In some examples, aspects of the operations of 905 may be performed by a cell search component 725 as described with reference to FIG. 7.

At 910, the method may include monitoring, in accordance with a first periodicity for respective SSBs, a first subset of raster points of the channel raster. The operations of 910 may be performed in accordance with examples as disclosed herein. In some examples, aspects of the operations of 910 may be performed by a first subset monitoring component 730 as described with reference to FIG. 7.

At 915, the method may include monitoring, in accordance with a second periodicity for respective SSBs, a second subset of raster points of the channel raster. The operations of 915 may be performed in accordance with examples as disclosed herein. In some examples, aspects of the operations of 915 may be performed by a second subset monitoring component 735 as described with reference to FIG. 7.

At 920, the method may include determining a presence of one or more cells in the first subset of raster points or in the second subset of raster points based on the monitoring. The operations of 920 may be performed in accordance with examples as disclosed herein. In some examples, aspects of the operations of 920 may be performed by a cell presence component 740 as described with reference to FIG. 7.

At 925, the method may include communicating with one or more cells based on performing the cell search process. The operations of 925 may be performed in accordance with examples as disclosed herein. In some examples, aspects of the operations of 925 may be performed by a cell communication component 745 as described with reference to FIG. 7.

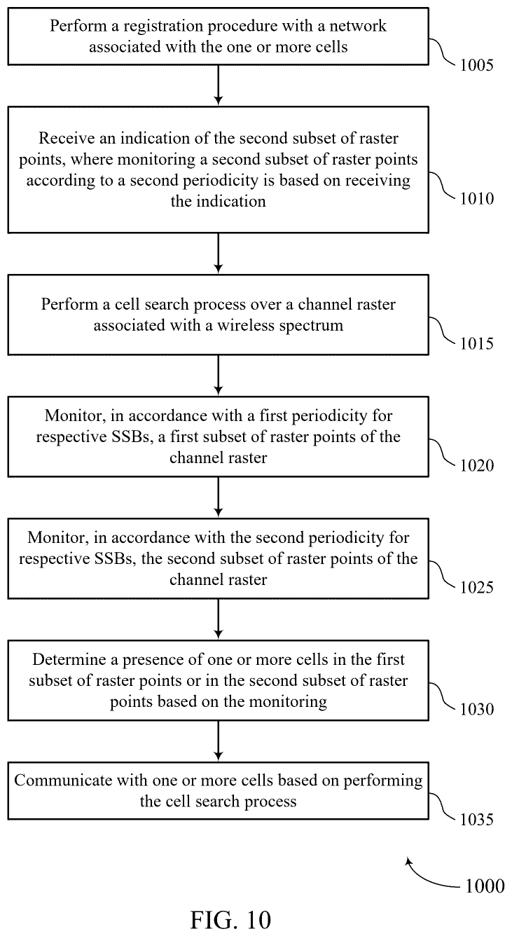

FIG. 10 shows a flowchart illustrating a method 1000 that supports extending SSB periodicities for NTNs in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include performing a registration procedure with a network associated with the one or more cells. The operations of 1005 may be performed in accordance with examples as disclosed herein. In some examples, aspects of the operations of 1005 may be performed by a network registration component 750 as described with reference to FIG. 7.

At 1010, the method may include receiving, prior to performing the cell search process, an indication of the second subset of raster points, where monitoring the second subset of raster points according to the second periodicity is based on receiving the indication. The operations of 1010 may be performed in accordance with examples as disclosed herein. In some examples, aspects of the operations of 1010 may be performed by a raster point indication component 755 as described with reference to FIG. 7.

At 1015, the method may include performing a cell search process over a channel raster associated with a wireless spectrum, where performing the cell search process includes monitoring raster points and determining a presence of one or more cells based on the monitoring. The operations of 1015 may be performed in accordance with examples as disclosed herein. In some examples, aspects of the operations of 1015 may be performed by a cell search component 725 as described with reference to FIG. 7.

At 1020, the method may include monitoring, in accordance with a first periodicity for respective SSBs, a first subset of raster points of the channel raster. The operations of 1020 may be performed in accordance with examples as disclosed herein. In some examples, aspects of the operations of 1020 may be performed by a first subset monitoring component 730 as described with reference to FIG. 7.

At 1025, the method may include monitoring, in accordance with a second periodicity for respective SSBs, a second subset of raster points of the channel raster. The operations of 1025 may be performed in accordance with examples as disclosed herein. In some examples, aspects of the operations of 1025 may be performed by a second subset monitoring component 735 as described with reference to FIG. 7.

At 1030, the method may include determining a presence of one or more cells in the first subset of raster points or in the second subset of raster points based on the monitoring. The operations of 1030 may be performed in accordance with examples as disclosed herein. In some examples, aspects of the operations of 1030 may be performed by a cell presence component 740 as described with reference to FIG. 7.

At 1035, the method may include communicating with one or more cells based on performing the cell search process. The operations of 1035 may be performed in accordance with examples as disclosed herein. In some examples, aspects of the operations of 1035 may be performed by a cell communication component 745 as described with reference to FIG. 7.

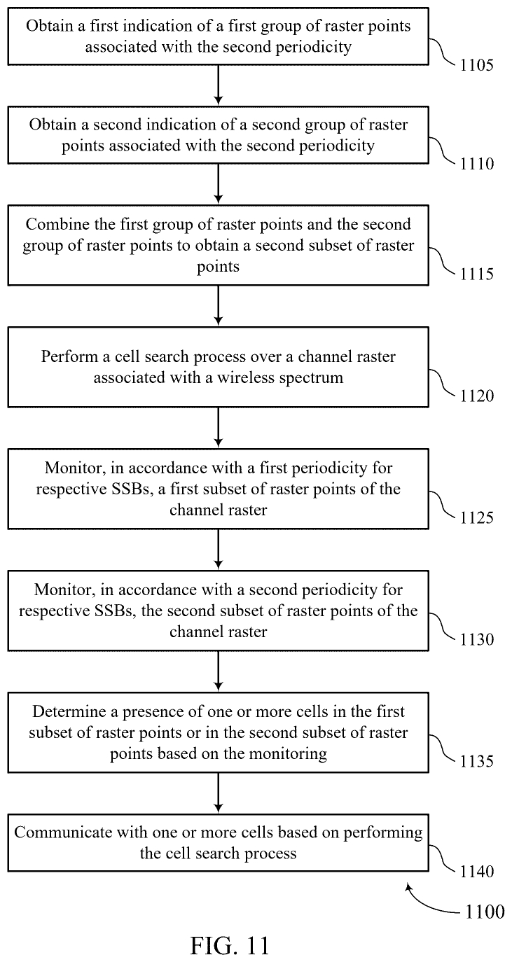

FIG. 11 shows a flowchart illustrating a method 1100 that supports extending SSB periodicities for NTNs in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include obtaining a first indication of a first group of raster points associated with the second periodicity. The operations of 1105 may be performed in accordance with examples as disclosed herein. In some examples, aspects of the operations of 1105 may be performed by a first raster point group indication component 760 as described with reference to FIG. 7.

At 1110, the method may include obtaining a second indication of a second group of raster points associated with the second periodicity. The operations of 1110 may be performed in accordance with examples as disclosed herein. In some examples, aspects of the operations of 1110 may be performed by a second raster point group indication component 765 as described with reference to FIG. 7.

At 1115, the method may include combining the first group of raster points and the second group of raster points to obtain the second subset of raster points. The operations of 1115 may be performed in accordance with examples as disclosed herein. In some examples, aspects of the operations of 1115 may be performed by a raster point combination component 770 as described with reference to FIG. 7.

At 1120, the method may include performing a cell search process over a channel raster associated with a wireless spectrum, where performing the cell search process includes monitoring raster points and determining a presence of one or more cells based on the monitoring. The operations of 1120 may be performed in accordance with examples as disclosed herein. In some examples, aspects of the operations of 1120 may be performed by a cell search component 725 as described with reference to FIG. 7.

At 1125, the method may include monitoring, in accordance with a first periodicity for respective SSBs, a first subset of raster points of the channel raster. The operations of 1125 may be performed in accordance with examples as disclosed herein. In some examples, aspects of the operations of 1125 may be performed by a first subset monitoring component 730 as described with reference to FIG. 7.

At 1130, the method may include monitoring, in accordance with a second periodicity for respective SSBs, a second subset of raster points of the channel raster. The operations of 1130 may be performed in accordance with examples as disclosed herein. In some examples, aspects of the operations of 1130 may be performed by a second subset monitoring component 735 as described with reference to FIG. 7.

At 1135, the method may include determining a presence of one or more cells in the first subset of raster points or in the second subset of raster points based on the monitoring. The operations of 1135 may be performed in accordance with examples as disclosed herein. In some examples, aspects of the operations of 1135 may be performed by a cell presence component 740 as described with reference to FIG. 7.

At 1140, the method may include communicating with one or more cells based on performing the cell search process. The operations of 1140 may be performed in accordance with examples as disclosed herein. In some examples, aspects of the operations of 1140 may be performed by a cell communication component 745 as described with reference to FIG. 7.

It should be noted that the methods described herein describe possible implementations. The operations and the steps may be rearranged or otherwise modified and other implementations are possible. Further, aspects from two or more of the methods may be combined.

The following provides an overview of aspects of the present disclosure:
Aspect 1: A method for wireless communications at a UE, comprising: performing a cell search process over a channel raster associated with a wireless spectrum, wherein performing the cell search process comprises: monitoring, in accordance with a first periodicity for respective SSBs, a first subset of raster points of the channel raster; monitoring, in accordance with a second periodicity for respective SSBs, a second subset of raster points of the channel raster; and determining a presence of one or more cells in the first subset of raster points or in the second subset of raster points based at least in part on the monitoring; and communicating with one or more cells based at least in part on performing the cell search process.
Aspect 2: The method of aspect 1, wherein the second subset of raster points are based at least in part on information contained in a SIM, a GSCN, an ARFCN, a frequency band associated with the raster points, an NT deployment associated with the one or more cells, an SCS, or any combination thereof.
Aspect 3: The method of any of aspects 1 through 2, wherein the second subset of raster points are a subset of a set of raster points that support the second periodicity.
Aspect 4: The method of any of aspects 1 through 3, further comprising: performing a registration procedure with a network associated with the one or more cells; and receiving, prior to performing the cell search process, an indication of the second subset of raster points, wherein monitoring the second subset of raster points according to the second periodicity is based at least in part on receiving the indication.
Aspect 5: The method of aspect 4, further comprising: transmitting an indication of a quantity of supported raster points associated with the second periodicity, wherein the second subset of raster points comprises a quantity of raster points that is less than or equal to the quantity of the supported raster points.
Aspect 6: The method of any of aspects 4 through 5, further comprising: receiving a message comprising a set of neighbor cell frequencies, wherein the message comprises the second subset of raster points.
Aspect 7: The method of any of aspects 1 through 6, further comprising: obtaining a first indication of a first group of raster points associated with the second periodicity; obtaining a second indication of a second group of raster points associated with the second periodicity; and combining the first group of raster points and the second group of raster points to obtain the second subset of raster points.
Aspect 8: The method of aspect 7, wherein combining the first group of raster points and the second group of raster points comprises: determining that a combination of the first group of raster points and the second group of raster points exceeds a quantity threshold; and applying one or more prioritization criteria to obtain the second subset of raster points from the first and second groups of raster points, wherein the second subset of raster points satisfies the threshold.
Aspect 9: The method of aspect 8, wherein the one or more prioritization criteria comprises a ranking of a source of the first indication and a source of the second indication, respective priorities associated with respective raster points of the first group of raster points and the second group of raster points, or any combination thereof.
Aspect 10: The method of any of aspects 1 through 9, further comprising: obtaining a first indication of a first group of raster points associated with the second periodicity and a first source; obtaining a second indication of a second group of raster points associated with the second periodicity and a second source; and determining a priority associated with the first source is higher than a priority associated with the second source to obtain the second subset of raster points from the first group of raster points.
Aspect 11: The method of any of aspects 1 through 10, wherein the second periodicity is a fixed duration.
Aspect 12: The method of aspect 11, wherein the fixed duration is based at least in part on a frequency band, a GSCN, or both.
Aspect 13: The method of any of aspects 1 through 12, further comprising: receiving an indication of the second periodicity, wherein the second periodicity satisfies a threshold duration and corresponds to a respective raster point.
Aspect 14: The method of any of aspects 1 through 13, further comprising: transmitting an indication of a capability to support the second periodicity, wherein the indication comprises a respective capability for a respective frequency band, a quantity of raster points the UE supports for the second periodicity, or both.
Aspect 15: A UE for wireless communications, comprising one or more memories storing processor-executable code, and one or more processors coupled with the one or more memories and individually or collectively operable to execute the code to cause the UE to perform a method of any of aspects 1 through 14.
Aspect 16: A UE for wireless communications, comprising at least one means for performing a method of any of aspects 1 through 14.
Aspect 17: A non-transitory computer-readable medium storing code for wireless communications, the code comprising instructions executable by one or more processors to perform a method of any of aspects 1 through 14.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
perform a cell search process over a channel raster associated with a wireless spectrum, wherein performing the cell search process comprises:
monitor, in accordance with a first periodicity for respective synchronization signal blocks, a first subset of raster points of the channel raster;
monitor, in accordance with a second periodicity for respective synchronization signal blocks, a second subset of raster points of the channel raster; and
determine a presence of one or more cells in the first subset of raster points or in the second subset of raster points based at least in part on the monitoring; and
communicate with one or more cells based at least in part on performing the cell search process.

2. The UE of claim 1, wherein the second subset of raster points are based at least in part on information contained in a subscriber identity module, a global synchronization channel number, an absolute radio frequency channel number, a frequency band associated with the raster points, a non-terrestrial deployment associated with the one or more cells, a subcarrier spacing, or any combination thereof.

3. The UE of claim 1, wherein the second subset of raster points are a subset of a set of raster points that support the second periodicity.

4. The UE of claim 1, wherein the one or more processors are individually or collectively further operable to execute the code to cause the UE to:
perform a registration procedure with a network associated with the one or more cells; and
receive, prior to performing the cell search process, an indication of the second subset of raster points, wherein monitoring the second subset of raster points according to the second periodicity is based at least in part on receiving the indication.

5. The UE of claim 4, wherein the one or more processors are individually or collectively further operable to execute the code to cause the UE to:
transmit an indication of a quantity of supported raster points associated with the second periodicity, wherein the second subset of raster points comprises a quantity of raster points that is less than or equal to the quantity of the supported raster points.

6. The UE of claim 4, wherein the one or more processors are individually or collectively further operable to execute the code to cause the UE to:
receive a message comprising a set of neighbor cell frequencies, wherein the message comprises the second subset of raster points.

7. The UE of claim 1, wherein the one or more processors are individually or collectively further operable to execute the code to cause the UE to:
obtain a first indication of a first group of raster points associated with the second periodicity;
obtain a second indication of a second group of raster points associated with the second periodicity; and
combine the first group of raster points and the second group of raster points to obtain the second subset of raster points.

8. The UE of claim 7, wherein, to combine the first group of raster points and the second group of raster points, the one or more processors are individually or collectively operable to execute the code to cause the UE to:
determine that a combination of the first group of raster points and the second group of raster points exceeds a quantity threshold; and
apply one or more prioritization criteria to obtain the second subset of raster points from the first and second groups of raster points, wherein the second subset of raster points satisfies the threshold.

9. The UE of claim 8, wherein the one or more prioritization criteria comprises a ranking of a source of the first indication and a source of the second indication, respective priorities associated with respective raster points of the first group of raster points and the second group of raster points, or any combination thereof.

10. The UE of claim 1, wherein the one or more processors are individually or collectively further operable to execute the code to cause the UE to:
obtain a first indication of a first group of raster points associated with the second periodicity and a first source;
obtain a second indication of a second group of raster points associated with the second periodicity and a second source; and
determine a priority associated with the first source is higher than a priority associated with the second source to obtain the second subset of raster points from the first group of raster points.

11. The UE of claim 1, wherein the second periodicity is a fixed duration.

12. The UE of claim 11, wherein the fixed duration is based at least in part on a frequency band, a global synchronization channel number, or both.

13. The UE of claim 1, wherein the one or more processors are individually or collectively further operable to execute the code to cause the UE to:
receive an indication of the second periodicity, wherein the second periodicity satisfies a threshold duration and corresponds to a respective raster point.

14. The UE of claim 1, wherein the one or more processors are individually or collectively further operable to execute the code to cause the UE to:
transmit an indication of a capability to support the second periodicity, wherein the indication comprises a respective capability for a respective frequency band, a quantity of raster points the UE supports for the second periodicity, or both.

15. A method for wireless communications at a user equipment (UE), comprising:
performing a cell search process over a channel raster associated with a wireless spectrum, wherein performing the cell search process comprises:
monitoring, in accordance with a first periodicity for respective synchronization signal blocks, a first subset of raster points of the channel raster;
monitoring, in accordance with a second periodicity for respective synchronization signal blocks, a second subset of raster points of the channel raster; and
determining a presence of one or more cells in the first subset of raster points or in the second subset of raster points based at least in part on the monitoring; and
communicating with one or more cells based at least in part on performing the cell search process.

16. The method of claim 15, wherein the second subset of raster points are based at least in part on information contained in a subscriber identity module, a global synchronization channel number, an absolute radio frequency channel number, a frequency band associated with the raster points, a non-terrestrial deployment associated with the one or more cells, a subcarrier spacing, or any combination thereof.

17. The method of claim 15, further comprising:
performing a registration procedure with a network associated with the one or more cells; and
receiving, prior to performing the cell search process, an indication of the second subset of raster points, wherein monitoring the second subset of raster points according to the second periodicity is based at least in part on receiving the indication.

18. The method of claim 15, further comprising:
transmitting an indication of a capability to support the second periodicity, wherein the indication comprises a respective capability for a respective frequency band, a quantity of raster points the UE supports for the second periodicity, or both.

19. A non-transitory computer-readable medium storing code for wireless communications, the code comprising instructions executable by one or more processors to:
perform a cell search process over a channel raster associated with a wireless spectrum, wherein performing the cell search process comprises:
monitor, in accordance with a first periodicity for respective synchronization signal blocks, a first subset of raster points of the channel raster;
monitor, in accordance with a second periodicity for respective synchronization signal blocks, a second subset of raster points of the channel raster; and
determine a presence of one or more cells in the first subset of raster points or in the second subset of raster points based at least in part on the monitoring; and
communicate with one or more cells based at least in part on performing the cell search process.

20. The non-transitory computer-readable medium of claim 19, wherein the instructions are further executable by the one or more processors to:
obtain a first indication of a first group of raster points associated with the second periodicity;
obtain a second indication of a second group of raster points associated with the second periodicity; and
combine the first group of raster points and the second group of raster points to obtain the second subset of raster points.
